(19) United States
(12) Patent Application Publication
(10) Pub. No.: US 2024/0191388 A1
(43) Pub. Date: Jun. 13, 2024

(54) ELECTROLYTIC POLISHING TREATMENT METHOD FOR NICKEL-BASED ALLOY WORKPIECE

(71) Applicant: NATIONAL CHUNG SHAN INSTITUTE OF SCIENCE AND TECHNOLOGY, Taoyuan City (TW)

(72) Inventors: CHUN-HSIANG KAO, Taoyuan City (TW); YI-CHERNG FERNG, Taoyuan City (TW); YING-SUN HUANG, Taoyuan City (TW); KUO-KUANG JEN, Taoyuan City (TW); SHUN-YI JIAN, Taoyuan City (TW); CHIA-YU LEE, Taoyuan City (TW); JUNG-CHOU HUNG, Taoyuan City (TW); PO-JEN YANG, Taoyuan City (TW)

(21) Appl. No.: 18/531,721

(22) Filed: Dec. 7, 2023

(30) Foreign Application Priority Data
Dec. 7, 2022 (TW) 111146998

(51) Int. Cl. C25F 3/22; B01J 19/10; B24C 1/08

(52) U.S. Cl. CPC C25F 3/22; B01J 19/10; B24C 1/08

(57) ABSTRACT

An electrolytic polishing treatment method for a nickel-based alloy workpiece made by lamination manufacturing comprises the following steps. Step (A) comprises performing a sandblasting treatment on the nickel-based alloy workpiece, followed by ultrasonic oscillation of the sandblasted nickel-based alloy workpiece in an oxalic acid solution. Step (B) comprises placing the nickel-based alloy workpiece in an electrolyte solution containing methanol, sulfuric acid, and perchloric acid and performing electrolytic polishing on the nickel-based alloy workpiece at a constant voltage after step (A). The processes of oxalic acid activation and electrolytic polishing are used to avoid the problems of residual stress and processing directionality caused by conventional mechanical processing and make the surface properties of the entire workpiece uniform.

### CROSS-REFERENCE TO RELATED APPLICATION

This non-provisional application claims priority under 35 U.S.C. § 119(a) on Patent Application No(s). 111146998 filed in Taiwan, R.O.C. on Dec. 7, 2022, the entire contents of which are hereby incorporated by reference.

### BACKGROUND OF THE INVENTION

### 1. Field of the Invention

The present disclosure relates to metal processing technology, and in particular to an electrolytic polishing treatment method for surface leveling of nickel-based alloy workpieces manufactured by lamination.

### 2. Description of the Related Art

Metal laminated manufacturing is one of the key technologies in the current manufacturing of ultra-precision metal components. It can effectively solve the problems of processing requirements in high-value molds, special metal components, complex structural shapes, and internal flow channels, and is the future development trend in the metal precision processing industry. Among them, nickel-based alloy workpieces made of metal laminates have excellent high-temperature mechanical strength and corrosion resistance. Together with iron-based alloys and cobalt-based alloys, they are called superalloys and can be used in high-temperature environments above 540° C., special corrosion-resistant environments, high-temperature corrosion environments, and equipment that require high-temperature mechanical strength. Therefore, nickel-based alloy workpieces made of laminated metal have become one of the next main application materials in the national defense, aerospace, and medical industries.

However, the above-mentioned industries have very high requirements for the precision dimensions of nickel-based alloy workpieces manufactured by metal lamination and have higher requirements for the flatness and roughness of the workpiece surface. In particular, it is more technically difficult to meet the above requirements for blade workpieces with complex torsional curved surfaces and thin plate characteristics. Therefore, if the surface roughness of the material can be reduced, it can not only prevent stress concentration caused by material surface defects and reduce mechanical vibration and wear, but also increase the service life of the workpiece material.

Specifically, although metal products with complex shapes, complex flow channels, and internal structures can be produced through the metal laminated manufacturing method, it has the disadvantage of excessive surface roughness of the product. Therefore, it must be processed through subsequent processing to meet the needs of commercialization. At present, subsequent precision grinding and polishing processes can include, for example, grinding, lapping, mechano-chemical polishing, chemo-mechanical polishing, etc., but these technologies have limitations in shape and precision and may cause processing deterioration and residual stress.

In addition, commonly used metal processing technologies also include mechanical cutting processing and laser processing. However, mechanical cutting processing will form a plastic deformation layer on the surface of the workpiece, and there is processing directionality. This phenomenon will result in the inability to accurately reflect the true structure and properties of the metal workpiece. On the other hand, laser processing is prone to the accumulation of recast layers on the metal surface.

Therefore, to solve the above problems, it has been proposed the processing technology of electrolytic polishing, which is a processing technology based on the principle of anodic dissolution to flatten and gloss the surface of the workpiece. In addition, the anodic dissolution of electrolytic polishing has no processing directionality and can preferentially dissolve the plastic deformation layer on the metal surface. In this way, in addition to achieving the effect of removing residual stress on the surface, the surface roughness and mirror gloss of the workpiece after electrolytic polishing are superior to those of conventional metal processing techniques.

### BRIEF SUMMARY OF THE INVENTION

However, although electrolytic polishing technology has the advantages of not producing a deteriorated layer on the polished surface, no additional stress, and being able to process workpieces with complex shapes or small sizes, electrolytic polishing technology may also cause uneven anode dissolution during the electrolytic polishing process due to insufficient reactivity or electrolyte composition, resulting in the polished workpiece being unable to achieve the expected roughness and gloss.

Therefore, in order to improve the shortcomings of the prior art, the present disclosure provides an electrolytic polishing method for nickel-based alloy workpieces. By using the processes of oxalic acid activation and electrolytic polishing, the present disclosure can avoid the problems of residual stress and processing directionality caused by the conventional technology, and make the surface properties of the entire workpiece uniform.

The present disclosure relates to an electrolytic polishing treatment method for a nickel-based alloy workpiece. The nickel-based alloy workpiece is manufactured by lamination. The electrolytic polishing treatment method includes the following steps: (A) performing a sandblasting treatment on the nickel-based alloy workpiece, followed by ultrasonic oscillation of the sandblasted nickel-based alloy workpiece in an oxalic acid solution; and (B) placing the nickel-based alloy workpiece in an electrolyte solution containing methanol, sulfuric acid, and perchloric acid and performing electrolytic polishing on the nickel-based alloy workpiece at a constant voltage after step (A).

In an embodiment of the present disclosure, the sandblasting treatment in step (A) uses emery.

In an embodiment of the present disclosure, the oxalic acid solution in step (A) has a concentration of 5 to 15 vol %.

In an embodiment of the present disclosure, the ultrasonic oscillation in step (A) has an operation time of 5 to 10 minutes, an operation temperature of 20 to 30° ° C., and an oscillation frequency of 30 to 50 kHz.

In an embodiment of the present disclosure, the electrolyte solution of step (B) comprises 80 vol % or more of methanol, 4.5 vol % or more of sulfuric acid, and 12 vol % or more of perchloric acid.

In an embodiment of the present disclosure, in the electrolyte solution of step (B), a volume ratio of methanol:sulfuric acid:perchloric acid is 18:1:3.

In an embodiment of the present disclosure, the constant voltage of step (B) has a range of 10 to 15V.

In an embodiment of the present disclosure, the electrolytic polishing of step (B) has a reaction time of 15 to 20 minutes and an operation temperature of 0 to 30° C.

In an embodiment of the present disclosure, materials of the nickel-based alloy workpiece comprise a nickel-based powder and modified powder thereof. Specifically, the nickel-based powder and modified powder thereof include Inconel® 625, Inconel® 713, Inconel® 713LC, Inconel® 718, Inconel® 718 plus, etc.

In an embodiment of the present disclosure, the nickel-based alloy workpiece is in a heat-treated state or a rough blank state resulting from lamination manufacturing.

The above summary and the following detailed description and drawings are all intended to further illustrate the methods, means, and effects adopted by the present disclosure to achieve the intended purpose. Other objects and advantages of the present disclosure will be elaborated in the subsequent description and drawings.

### BRIEF DESCRIPTION OF THE DRAWINGS

FIG. 1 is a diagram showing the implementation steps of an electrolytic polishing treatment method for a nickel-based alloy workpiece according to an embodiment of the present disclosure.

FIG. 2 shows scanning electron microscope (SEM) images of the workpiece at each stage of the electrolytic polishing treatment process according to an embodiment of the present disclosure, wherein (a) shows the unprocessed workpiece surface, (b) shows the workpiece surface after step (A), and (c) shows the workpiece surface after step (B).

FIG. 3 shows 3D white light roughness measurement diagrams of the workpiece at various stages of the electrolytic polishing treatment process according to an embodiment of the present disclosure, wherein (a) shows the unprocessed workpiece surface, (b) shows the workpiece surface after step (A), and (c) shows the workpiece surface after step (B).

### DETAILED DESCRIPTION OF THE INVENTION

The following is an illustration of the implementations of the present disclosure through specific examples. Those familiar with the art can easily understand other advantages and effects of the present disclosure from the content disclosed in this specification.

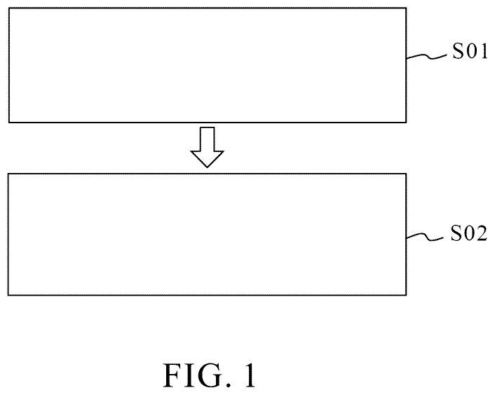

The implementation step diagram of the electrolytic polishing treatment method of the nickel-based alloy workpiece according to an embodiment of the present disclosure is shown in FIG. 1. The implementation steps include:

S01: (A) Oxalic acid activation step, which involves sandblasting the nickel-based alloy workpiece, placing the sandblasted nickel-based alloy workpiece in an oxalic acid solution, and performing ultrasonic oscillation on the nickel-based alloy workpiece. In a specific example, the operation time of the ultrasonic oscillation is 5 to 10 minutes, the operation temperature is 20 to 30° C., and the oscillation frequency is 30 to 50 kHz. Moreover, in a specific example, the concentration of the oxalic acid solution is 5 to 15 vol %.

S02: (B) Electrolytic polishing step, which involves placing the nickel-based alloy workpiece after step (A) into an electrolyte solution containing methanol, sulfuric acid, and perchloric acid, and performing electrolytic polishing on the nickel-based alloy workpiece at a constant voltage. In a specific example, the constant voltage ranges from 10 to 15V. Moreover, in a specific example, the operation temperature of the electrolytic polishing ranges from 0 to 30° C., and the reaction time ranges from 15 to 20 minutes.

The process conditions of a preferred embodiment of the present disclosure are as follows: in step (A), the oxalic acid concentration is 10 vol %, the treatment time of ultrasonic oscillation is 5 minutes, the operation temperature is 25° C., and the oscillation frequency is 40 kHz. In step (B), the electrolyte solution contains 900 ml of methanol, 50 ml of sulfuric acid, and 150 ml of perchloric acid, the constant voltage is set to 12V, the operation temperature of the electrolytic polishing is greater than 10° C., and the reaction time of the electrolytic polishing is 20 minutes.

In the present disclosure, because oxalic acid is an organic acid with weak acidity, oxalic acid will not cause obvious corrosion to the surface of nickel-based alloy workpieces in a short period of time, as compared with other inorganic acids with stronger acidity (such as nitric acid, sulfuric acid, etc.) that will cause obvious corrosion to the surface of the nickel-based alloy workpiece in a short period of time. In addition, although organic acids such as formic acid and acetic acid are as easy to obtain as oxalic acid and have similar costs, oxalic acid has a less irritating odor and is less harmful to human skin, as compared with other organic acids, and is easy to store. Therefore, in the present disclosure, oxalic acid is used for activation.

In addition, in a preferred embodiment, the concentration of the oxalic acid solution is 5 to 15 vol %. If the concentration of the oxalic acid solution is too low (for example, less than 5 vol %), the desired activation effect cannot be achieved; and if the concentration of the oxalic acid solution is too high (for example, more than 15 vol %), the oxalic acid will over-etch the surface of the nickel-based superalloy, causing an uneven surface and affecting the smoothing effect after subsequent electropolishing.

Next, in an embodiment of the present disclosure, the electrolyte solution in step (B) contains 900 ml of methanol, 50 ml of sulfuric acid, and 150 ml of perchloric acid, that is, the volume ratio of methanol:sulfuric acid:perchloric acid is 18:1:3. Specifically, sulfuric acid can level the rough particles on the surface of the workpiece sample, while perchloric acid can level and smooth the surface of the workpiece sample. If the ratio of sulfuric acid is reduced or the ratio of perchloric acid is increased (for example, the volume ratio of sulfuric acid to perchloric acid is 1:1), it may result in that although the surface of the workpiece sample is smooth, the roughness will decrease less. On the other hand, if the ratio of perchloric acid is reduced or the ratio of sulfuric acid is increased (for example, the volume ratio of sulfuric acid to perchloric acid is 3:1), it may result in incomplete elimination of spherical particles on the surface of the workpiece sample. Therefore, the best electrolytic polishing effect can be obtained when the volume ratio of methanol: sulfuric acid: perchloric acid is 18:1:3.

In addition, in an embodiment of the present disclosure, the electrolytic polishing step can be divided into the following three sub-steps. Specifically, electrolytic polishing places the workpiece sample on the anode. During electrolytic polishing, the workpiece sample on the anode undergoes a dissolution reaction, followed by sub-steps of leveling, smoothing, and glossing to achieve the polishing effect. The principles of each sub-step are as follows:

Leveling: In the early stage of the reaction, the surface of the workpiece sample is relatively rough. At this time, the electric field intensity is relatively strong at the high points on the metal surface, and dissolution occurs at the high points on the surface. On the other hand, at low points on the surface, the dissolution rate is smaller due to the lower electric field intensity. Therefore, this step has the greatest leveling effect on the overall process. When the reaction proceeds for a period of time, a preliminary leveling effect can be achieved. This step also removes surface impurities.

Smoothing: When the reaction enters this step, metal ions will be released from the surface of the workpiece sample during electrolysis and dissolve into the electrolyte solution. The metal ions will combine with the acid ions in the electrolyte solution to form a thin film of reaction products (a barrier layer) on the anode surface. This barrier layer will vary depending on the electrolyte solution. Although the thickness of this barrier layer is thin, its resistance is very high, which will form a height difference on the surface being treated, thereby causing the high points to dissolve and the low points to be protected, so that the concentration of the electric field is relatively small. During this step, as the high points on the surface of the workpiece sample are dissolved for a long time, the height difference on the surface is gradually shortened, thereby achieving the surface smoothing effect.

Glossing: In this step, the surface of the workpiece sample with micro-roughness is eliminated. During this step, the viscous layer distributed on the surface of the workpiece sample is the place where micro-polishing occurs. At this time, the current density of the anode will become very small, causing trace removal at the high points under the microscopic level, and forming a protective effect at the low points without dissolution, thereby achieving a glossy effect on the workpiece sample.

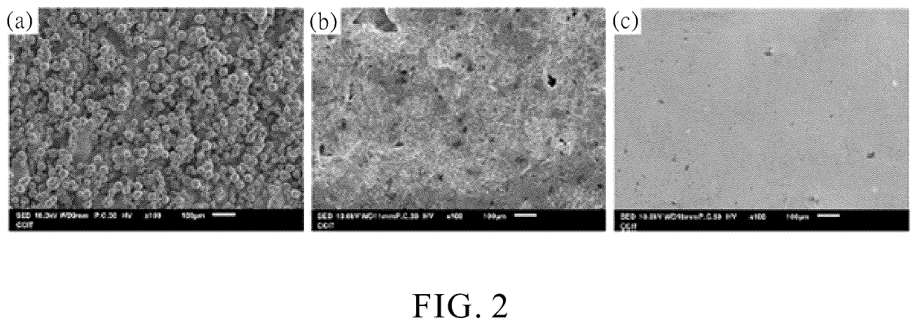

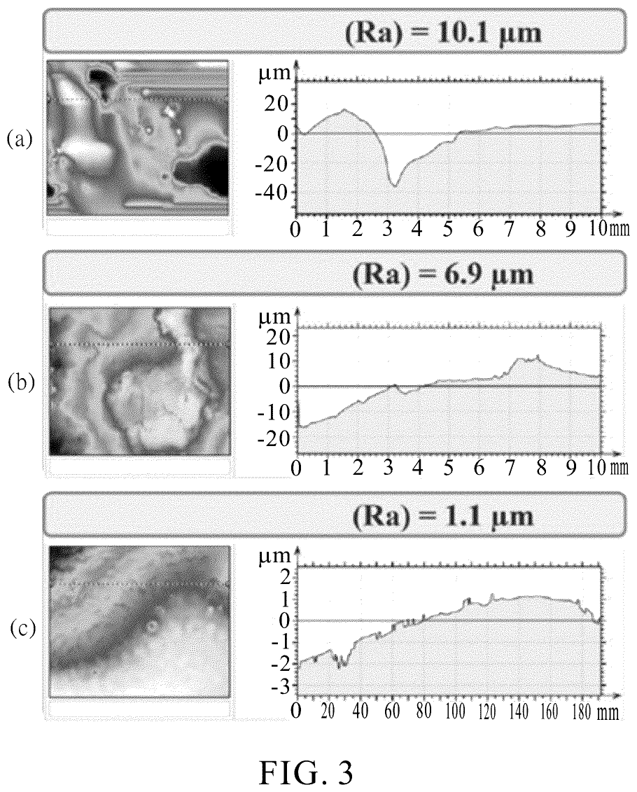

Next, please refer to FIGS. 2 to 3. FIG. 2 shows SEM images of the workpiece at each stage of the electrolytic polishing treatment process according to an embodiment of the present disclosure. FIG. 3 shows 3D white light roughness measurement diagrams of the workpiece at various stages of the electrolytic polishing treatment process according to an embodiment of the present disclosure. In FIGS. 2 and 3, (a) shows the unprocessed workpiece surface, (b) shows the workpiece surface after step (A), and (c) shows the workpiece surface after step (B).

It can be found from FIGS. 2 and 3 that step (A) of an embodiment of the present disclosure can reduce the surface roughness of the unprocessed nickel-based alloy workpiece manufactured by lamination from 10.1 μm to 6.9 μm. With the conduction of Step (B), the surface roughness can be further reduced to 1.1 μm, achieving an overall smooth and flat appearance. The above embodiments show that the electrolytic polishing process of the present disclosure can be effectively applied to the surface polishing of nickel-based alloy workpieces manufactured by lamination.

Thus, the present disclosure provides an electrolytic polishing treatment method for nickel-based alloy workpieces, which can improve the shortcomings of excessive surface roughness of conventional laminated nickel-based alloy workpieces to meet the commercialization requirements. The present disclosure can avoid the problems of residual stress and processing directionality resulting from conventional technology and make the surface properties of the entire workpiece uniform. The steps of the method used in the present disclosure are easily performed, and it is convenient to obtain individual components of the solution. In the future, it can be introduced with an automated electrolytic polishing process, and multiple workpieces can be polished and leveled simultaneously in a short time to achieve high-efficiency production. The present disclosure can be extended to the national defense and military industries, such as aircraft structures, space vehicles, artificial satellites, etc. Further, the present disclosure can also be applied to semiconductor, optoelectronics, aerospace, biochemical, medical, and precision machinery industries.

The embodiments described above are only exemplary to illustrate the characteristics and effects of the present invention and are not intended to limit the claimed scope of the present invention. Anyone skilled in the art can make modifications and changes to the above embodiments without departing from the spirit and scope of the invention. Therefore, the protection scope of the present invention should be as listed in the appended claims.

What is claimed is:

1. An electrolytic polishing treatment method of a nickel-based alloy workpiece made by lamination manufacturing comprises:
(A) performing a sandblasting treatment on the nickel-based alloy workpiece, followed by ultrasonic oscillation of the nickel-based alloy workpiece in an oxalic acid solution; and
(B) placing the nickel-based alloy workpiece in an electrolyte solution containing methanol, sulfuric acid, and perchloric acid and performing electrolytic polishing on the nickel-based alloy workpiece at a constant voltage after step (A).

2. The electrolytic polishing treatment method of a nickel-based alloy workpiece of claim 1, wherein the sandblasting treatment in step (A) uses emery.

3. The electrolytic polishing treatment method of a nickel-based alloy workpiece of claim 1, wherein the oxalic acid solution in step (A) has a concentration of 5 to 15 vol %.

4. The electrolytic polishing treatment method of a nickel-based alloy workpiece of claim 1, wherein the ultrasonic oscillation in step (A) has an operation time of 5 to 10 minutes, an operation temperature of 20 to 30° C., and an oscillation frequency of 30 to 50 kHz.

5. The electrolytic polishing treatment method of a nickel-based alloy workpiece of claim 1, wherein the electrolyte solution of step (B) comprises 80 vol % or more of methanol, 4.5 vol % or more of sulfuric acid, and 12 vol % or more of perchloric acid.

6. The electrolytic polishing treatment method of a nickel-based alloy workpiece of claim 1, wherein in the electrolyte solution of step (B), a volume ratio of methanol:sulfuric acid:perchloric acid is 18:1:3.

7. The electrolytic polishing treatment method of a nickel-based alloy workpiece of claim 1, wherein the constant voltage of step (B) has a range of 10 to 15V.

8. The electrolytic polishing treatment method of a nickel-based alloy workpiece of claim 1, wherein the electrolytic polishing of step (B) has a reaction time of 15 to 20 minutes and an operation temperature of 0 to 30° C.

9. The electrolytic polishing treatment method of a nickel-based alloy workpiece of claim 1, wherein materials of the nickel-based alloy workpiece comprise a nickel-based powder and modified powder thereof.

10. The electrolytic polishing treatment method of a nickel-based alloy workpiece of claim 1, wherein the nickel-based alloy workpiece is in a heat-treated state or a rough blank state resulting from lamination manufacturing.
